(19) United States
(12) Patent Application Publication
(10) Pub. No.: US 2009/0292838 A1
(43) Pub. Date: Nov. 26, 2009

(54) Simplified data transfer using intermediary

(76) Inventor: Ling Jun Wong, Escondido, CA (US)

Correspondence Address: MILLER PATENT SERVICES, 2500 DOCKERY LANE, RALEIGH, NC, 27606, US

(21) Appl. No.: 12/154,118

(22) Filed: May 20, 2008

(51) Int. Cl. G06F 3/00

(52) U.S. Cl. 710/52

(57) ABSTRACT

In certain embodiments consistent with the present invention, a method of transferring data from a source device to a destination device, using an intermediate device having pre-segmented storage involves receiving a user input associating a file type with a segment of the pre-segmented storage device; receiving a user input selecting a source port of the intermediate device; receiving a user input selecting a destination port of the intermediate device; receiving a user input selecting a segment of the pre-segmented storage device; determining a file type from the association of the selected segment of the pre-segmented storage device; and transferring the files of the determined file type from the source device to the destination device, wherein only files of the determined file type are transferred. This abstract is not to be considered limiting, since other embodiments may deviate from the features described in this abstract.

### CROSS REFERENCE TO RELATED DOCUMENTS

This application is related to U.S. patent application Ser. No. ______, filed May 2, 2008 entitled “Systematic Memory Shift for Pre-Segmented Memory”, to Ling Jun Wong, Docket No. SNY-X9215.01, and to U.S. patent application Ser. No. ______ filed on May, ______, 2008 entitled “Simplified Data Transfer Using Segmented Memory”, also to Lin Jun Wong, Docket Number SNY-X9211.01, both of which is hereby incorporated herein by reference.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Uploading pictures to a PC or laptop after an event or a long travel can be bothersome for busy people. This situation is made worse if there are more than one media to upload data from (such as a digital camera and a camcorder). The conventional solution for this problem is using conventional drag-and-drop methods from the external memory card to a PC disk drive. Another solution is to use computer software programs to do photo imports to import and organize the files.) Either technique This can be time consuming, especially when one desires to separate or organize files such as photos by categories such as multiple destinations on a vacation.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 depicts an exemplary segmented memory device such as a hard disc drive or a flash memory device consistent with certain embodiments of the present invention.

FIG. 2 is a flow chart of an example memory segmentation process consistent with certain embodiments of the present invention.

FIG. 3 is a block diagram of an example portable storage/transfer device 100 consistent with certain embodiments of the present invention.

FIG. 4 illustrates an embodiment of a portable storage/transfer device in perspective view consistent with certain embodiments of the present invention.

FIG. 5 illustrates an example rear panel of a portable storage/transfer device consistent with certain embodiments of the present invention.

FIG. 6 is an example upload or download process of a portable storage/transfer device consistent with certain embodiments of the present invention.

FIG. 7 is a first illustrative data flow illustration for an upload operation consistent with certain embodiments of the present invention.

FIG. 8 is a second illustrative data flow illustration for a download operation consistent with certain embodiments of the present invention.

FIG. 9 is a third illustrative data flow illustration for an upload followed by a download operation consistent with certain embodiments of the present invention.

FIG. 10 is a flow chart of an example folder creation process used at a PC upon first connection with the portable storage/transfer device consistent with certain embodiments of the present invention.

FIG. 11 is a flow chart of an example folder creation process used by the portable storage/transfer device in pushing data to a target in a manner consistent with certain embodiments.

FIG. 12 depicts an exemplary alternative physical embodiment of the portable storage and transfer device 100 in accord with certain embodiments consistent with the present invention.

FIG. 13 depicts an example process flow chart of an embodiment of the transfer and swap modes of operation of the portable storage and transfer device 100 in accord with certain embodiments consistent with the present invention.

FIG. 14 depicts another exemplary alternative physical embodiment of the portable storage and transfer device 100 in accord with certain embodiments consistent with the present invention.

FIG. 15 depicts another example process flow chart of an embodiment of the transfer and swap modes of operation of the portable storage and transfer device 100 in accord with certain embodiments consistent with the present invention.

FIG. 16 depicts an example process flow chart of an embodiment of the setup process for selection of a storage operation used in swap and transfer modes of operation of the portable storage and transfer device 100 in accord with certain embodiments consistent with the present invention.

FIG. 17 is a flow chart describing the operation of programming a sequence of data transfer operations in accord with embodiments consistent with the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an object method, an object implementation, in an executable application, an applet, a serviet, a source code, an object code, a shared library/dynamic load library and/or other sequence of instructions designed for execution on a computer system.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In each process described below, the copying and transfer process is one of appending files. Thus, the possibility of an accidental overwrite or loss of data is minimized. Data remains in the source, even after copying the data to the target. Erasure of data must be separately invoked.

In certain embodiments described below, storage such as a portable hard disk drive can be segmented by the user for his or her convenience. Once the memory is segmented, it can be used to facilitate simplified uploads and downloads as will be described.

The simplified upload feature allows data to be automatically transferred to another electronic device like a digital camera, a camcorder, flash memory card, a laptop, a personal computer (PC) or even TV receivers and other portable electronic devices like PDAs, PSP, etc as well. The simplified download feature does the opposite by simplifying transfer of data from a digital camera, camcorder, flash memory card, laptop or PC.

Using appropriate computer software, the disk drive or other storage device of a portable storage/transfer device (PSTD) is pre-segmented by the user to accommodate his or her intended use. Each segment is configured to contain certain data which the user wants to upload or download to another device directly. Data in different sections of memory can be transferred to the same device, to different devices, or to different folders in the same device (such as the case of a laptop). The source or destination device can be a digital camera, a camcorder, a laptop, a PC or any electronic device with one or more a processors.

The following are three example scenarios to narrate the use of this feature: Scenario 1:

The user downloads all data from a digital camera using the simplified download feature of the PSTD to segment 1. After which, the user then uploads all the downloaded pictures contained in segment I to the PC by applying the appropriate settings (set to “upload from section 1”). All these actions are carried out with minimal user interaction (other than determining the section number to be used and other simple configuration parameters). Scenario 2:

The user downloads data from digital camera to section I of the PSTD. Then the user automatically downloads data from a camcorder to section 2 of the PSTD. After which, the user then uploads the data from section 1 and section 2 to their respective folders on the PC in a single process. Scenario 3:

A traveler decides to go on a trip around the world. The traveler can make use of the memory segmentation feature to separate out the pictures taken from different places to different sections (eg, pictures taken in the US can be stored into segment 1, pictures taken in China can be stored in segment 2, etc), so that the pictures can be subsequently uploaded automatically to different folders on the PC when he returns from the trip. Again, minimal user interface is required to separate the pictures taken from different places.

By using a PC (with suitable software installed), the user is able to program the PSTD into specified sections as well as the corresponding directories on the PC for the specified sections.

By pressing the appropriate buttons on the PSTD or using a PC, a selected section of the memory can be erased for new data. By using the former method, an entire section of data is erased and it allows data erase to be performed in the field. By using the latter method, selected files can be erased leaving the other files intact.

In accordance with features consistent with certain embodiments, the memory segmentation feature can allow data differentiation, e.g., pictures from digital camera to one section, and videos from camcorder to another section. Simplified uploading eliminates the inconvenience of drag-and-drop. Data are automatically transferred upon plug-in.

Hence, by using memory segmentation, it is possible to separate data from different sources and transfer them to different destinations. Software can be installed on the PC to perform the required memory segmentation as will be described (e.g., by using flags), as well as select destination folders for uploads. Folders for each section can also be automatically created if only a single destination folder is given. Software drivers also allow for automatic device uploads (reads/writes) upon detection of device on USB port. By using this procedure, not only will simplified uploads be possible, but differentiated uploads are also possible.

The auto download feature can be implemented on many devices including, but not limited to laptop computers, Sony's Mylo™ Personal Communicators and Bravia™ TV, BIVL™ or other Internet Television devices, or any device that has a processor including cameras, audio devices, etc.

In certain preferred embodiments, installation software is used to allow for the automatic upload process upon detection of device on USB ports, to segment memory by using flags as well as to specify destination folders. Memory segmentation can also rely on the hardware architecture. To elaborate, since the flash memory is already divided into segments, it may be possible to make use of this existing segmentation instead of doing it in software. An advantage is the ease to implement the memory erase feature which the user will be able to perform on the PSTD itself in the field without a PC. Another advantage of certain embodiments is to allow the use of hardware acceleration for data transfers since data is data, and a jpeg is no different from an mpeg with respect to memory space. Hardware acceleration speeds up data transfers and consumes less power. It only needs to know the start and end addresses in the memory, which are coincidentally, the boundaries of the section. This method is not limited to divided flash memory, but also any set of memory that runs consecutively from the start to the end.

### Segmented Memory

Pre-segmented memory is described in the above-referenced patent application of the present inventor in the context of flash memory in which shifting of the data in the segments is carried out to prevent premature failure of the segmented memory. As noted therein, segmented memory can be useful in a variety of applications. Such applications include compartmentalizing data storage by data type (e.g., data, movies, pictures, music, etc.). When memory is used as segmented memory, the memory can either be pre-segmented by the manufacturer, or more preferably, segmented by the user. When segmented by the user, the segmentation can involve assignment of segments having differing sizes, so that for example, a 1 GB flash memory could be segmented into three segments with a first having 100 MB for data, a second having 300 MB for pictures and a third having 600 MB for videos, by way of illustrative example.

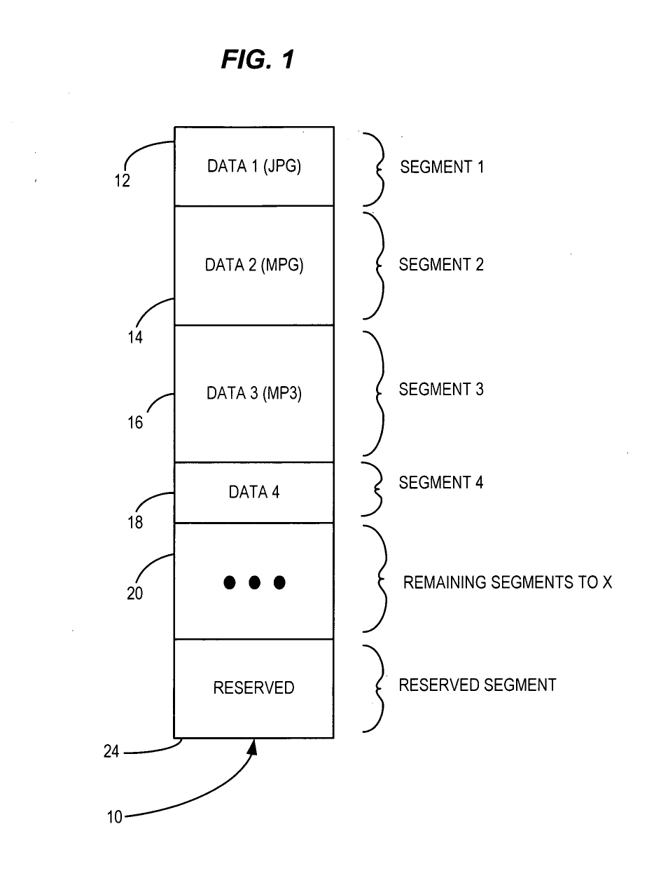

Turning now to FIG. 1, a segmented memory device such as a hard disk drive or flash memory is depicted as 10. In this embodiment, the memory is depicted as having been segmented into a plurality of segments 12, 14, 16, 18 representing segments 1, 2, 3 and 4 respectively. In general, there may be X such configurable segments with the segments 5 through X depicted as 20. A reserved segment may also be provided shown as 24 which may be used for various system or reserved functions. In the example depicted, segment 12 has been designated for data 1 which in this case is reserved for photographs in JPEG (.jpg) format. Segment 14 has been designated for data 2 which in this case is reserved for videos in MPEG (.mpg) format. Segment 16 has been designated for data 3 which in this case is reserved for music files in MP3 (.mp3) format. No designation is depicted for segments 18 and 20. When the memory is segmented and a filename extension is designated for the segment, other filename extensions are excluded from storage in the segment.

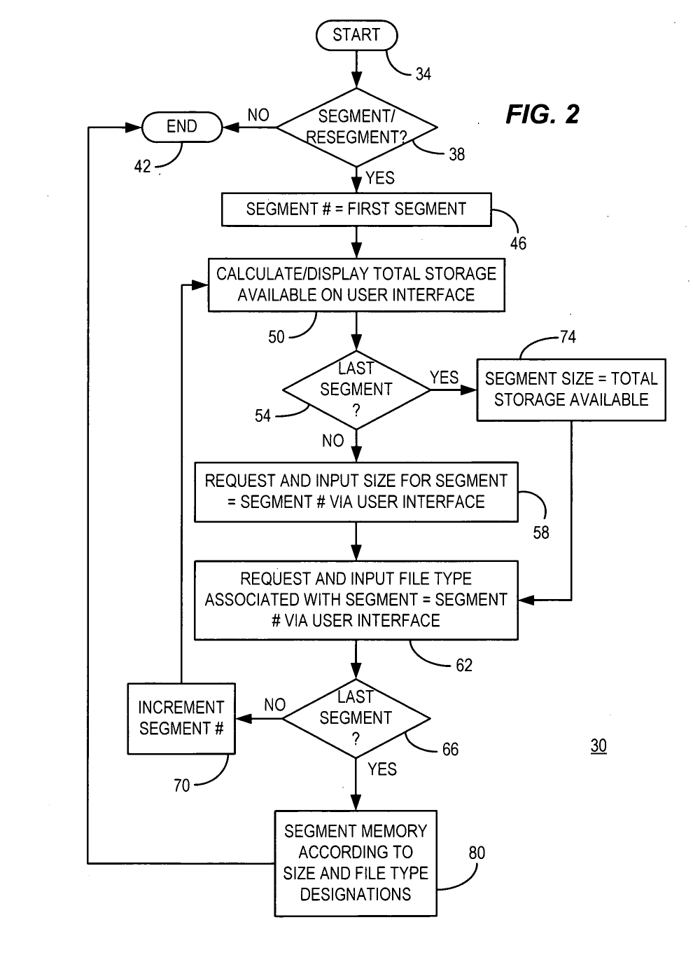

It will be noted that the segments depicted in memory 10 are shown of differing size. The size of each segment can be determined in the segmentation process depicted in FIG. 2 as process 30 starting at 34. This process is carried out by connection of the PSTD (which will be described later) to a programmed personal computer which carries out the segmentation process. When the process starts at 34, the user may either proceed with segmentation or abort the process at 38. If the process is aborted at 38, the process ends at 42. The segment number is initialized to the first segment at 46, and the amount of memory in the PSTD is calculated and displayed on a user interface (e.g., a window on the PC's monitor, a LCD or an LED display, or simply a memory bar on the PSTD) at 50 so that the user is reminded of how much data storage capacity is available.

On the first pass of this process, the segment number is the first segment, so when the segment number is checked to see if the last segment has been reached at 54, control passes to 58 where the segment number is displayed and the user is requested to provide an amount of memory to be allocated to this segment via the user interface. Once the user inputs the size, the user is requested via the interface to associate the current segment with a file type. Prompts or a list of file types that the user can browse can be provided, or the user can be required to directly enter the file type at 62. In certain embodiments, wild cards may be permitted in the filename extension for greater flexibility. If the last segment has not been reached at 66, then the segment number is incremented at 70 and the information entered by the user is temporarily saved for the segmentation process. Once the segment number is incremented at 70, control returns to 50 where the remaining storage is calculated and displayed and the process iterates.

Many variations are possible, for example, the order of 58 and 62 can be readily reversed, checking actions can be incorporated to prevent the user from entering too much memory in any segment, suggestions can be presented for the size allocated to a particular segment, error trapping can be added and other variations can be introduced without departing from embodiments consistent with the present invention.

When the last segment is reached at 54, the final segment size defaults to the remaining memory at 74 and control passes to 62 where the segment is associated with a file type. The last segment having been reached at 66, the memory is then segmented by appropriately flagging the memory or adjustment of the file allocation table (FAT) to effect the memory segmentation according to the designations made during the process. This process may also result in generation of a table in the reserved segment 24 of memory 10 which maps the file type designators (filename extensions) to the configured segments at 80 completing the process and returning to 42.

In certain embodiments, the reserved segment of storage device 10 or any unused or un-defined segments (that is, segments that do not have a filtering filename extension assigned thereto) can be used for operations that exceed the memory capacity of any given segment so that a programmed operation can still be successful even when the memory allocated for that segment is exceeded. When the reserved segment or unused or undefined segments are being utilized for such purposes, a special tag is given to the data to mark which section the data belongs to, so that future downloads/erasure from these sections can included as well. Thus, in essence, when these data are tagged, they belong to the tagged section, not in the unused section/reserved and all operations (upload/download/erasure) will be with regard to the tagged section. The space is only freed and returned to the unused section when the data is erased. In certain embodiments, the user may be alerted to such a condition so that a re-segmenting can be considered. Such embodiments may make the PSTD device 100 more adaptable and less prone to failures due to an inappropriate segmentation or data transfer instruction.

Many variations consistent with embodiments of present invention will be apparent to those skilled in the art upon consideration of the present teachings including providing suggested sizes for the segments, providing default data types or introducing new data types for greater flexibility, displaying of final results in a table form, providing for table entry, providing prompts to adjust for over allocation beyond PSTD's total capacity, error checking, providing checks for memory availability on the destination device for the data to be transferred and other variations. The process is preferably implemented in the form of a so-called “wizard” which has help functions embedded to assist users that are not computer savvy to distinguish between file types and to offer other forms of help. Other variations will occur to those skilled in the art upon consideration of the present teachings.

### Storage/Transfer Device

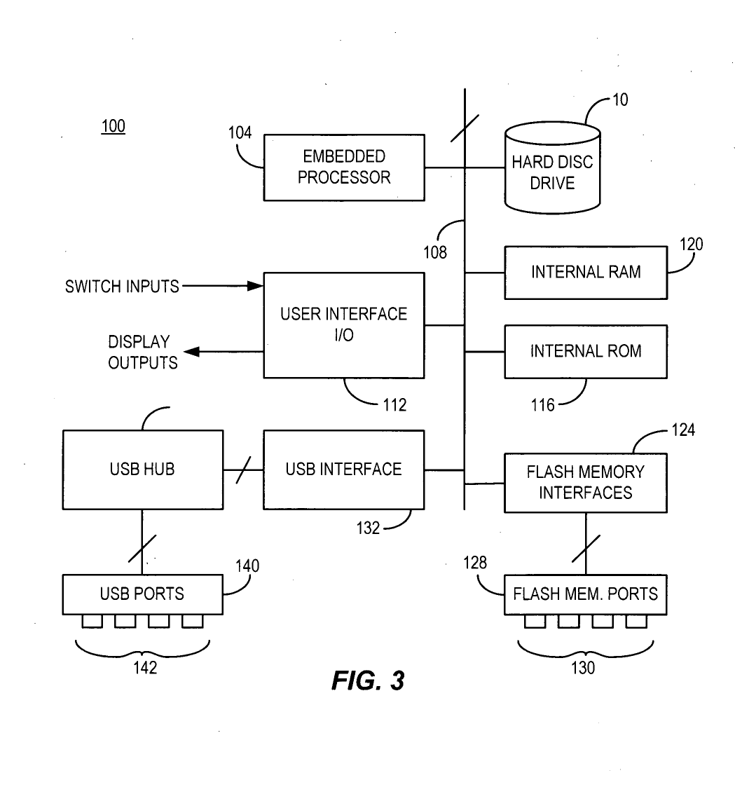

An exemplary hardware architecture for a PSTD is depicted in FIG. 3 as PSTD device 100. It is noted that reference number 100 is used throughout this document to refer to the multiple variations of the PSTD device. Those skilled in the art will appreciate that the devices may differ somewhat but by virtue of sharing a common set of hardware and functional characteristics, one reference number is used throughout.

The PSTD device 100 has a minimal computer or embedded processor 104 architecture used to support the hard disk drive 10 (and associated controller not shown) as well as various interfaces and memory devices interconnected by bus 108. A single bus 108 is depicted for ease of illustration, but multiple buses may be provided in a known manner. In the present embodiment, a user interface 112 is provided that permits outputs in the form of display lights (e.g., LED devices) or other simple display mechanism as well as simple switch inputs. Internal ROM and RAM 116 and 120 are provided for BIOS and working memory. The PSTD device 100 also operates with various interfaces such as flash memory interface 124 which interfaces the embedded processor 104 via bus 108 to one or more flash memory ports 128 of various types such as SD/MMC, xD picture card, Memory Stick™, Memory Stick Duo PrO™, compact flash, PCMCIA, and any other suitable format such as is depicted generally as 130. Other interfaces include a USB (e.g., USB 2.0) interface 132 to facilitate communication with external disc drives, PCs, cameras, and any other USB compatible device for which the present PSTD device 100 is applicable. USB interface 132 may be coupled to a USB hub 136 that breaks out the USB interface into multiple USB ports 140 such as are generally depicted as 142. Other interfaces including IEEE 1394 or HDMI or other interfaces can also be provided without deviating from embodiments consistent with the present invention.

In operation, external devices such as cameras, memory cards and PCs can be connected to the PSTD device 100 via the interfaces and data transferred either to or from the external devices to the hard disc drive it the mode of operation for which the present discussion is directed as will become apparent upon consideration of the following discussion.

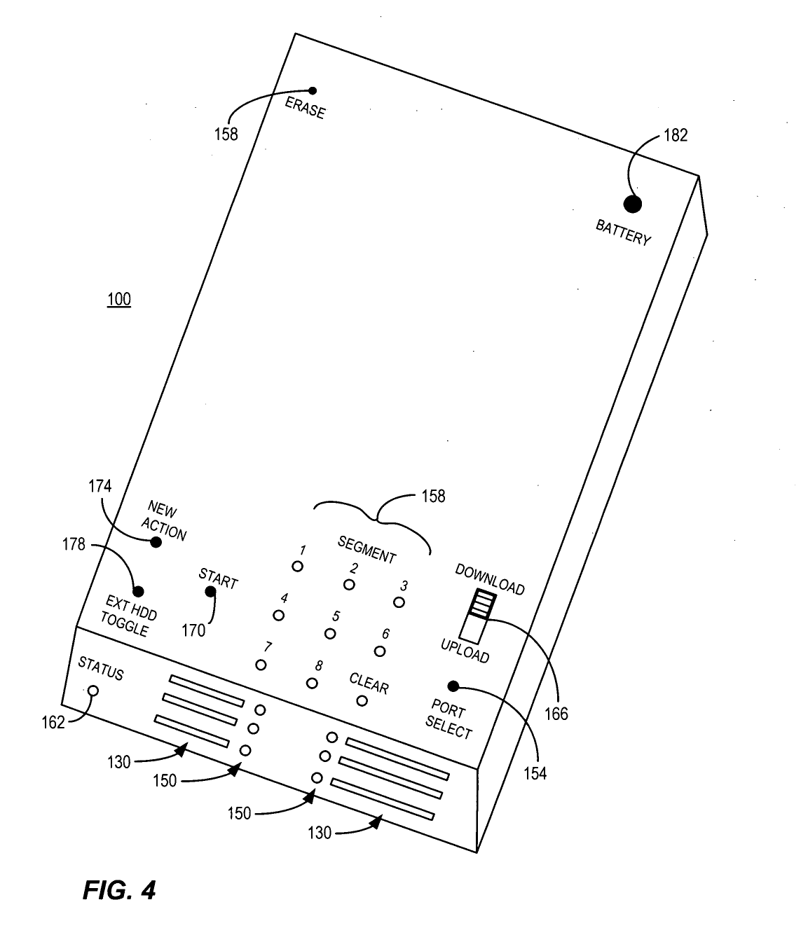

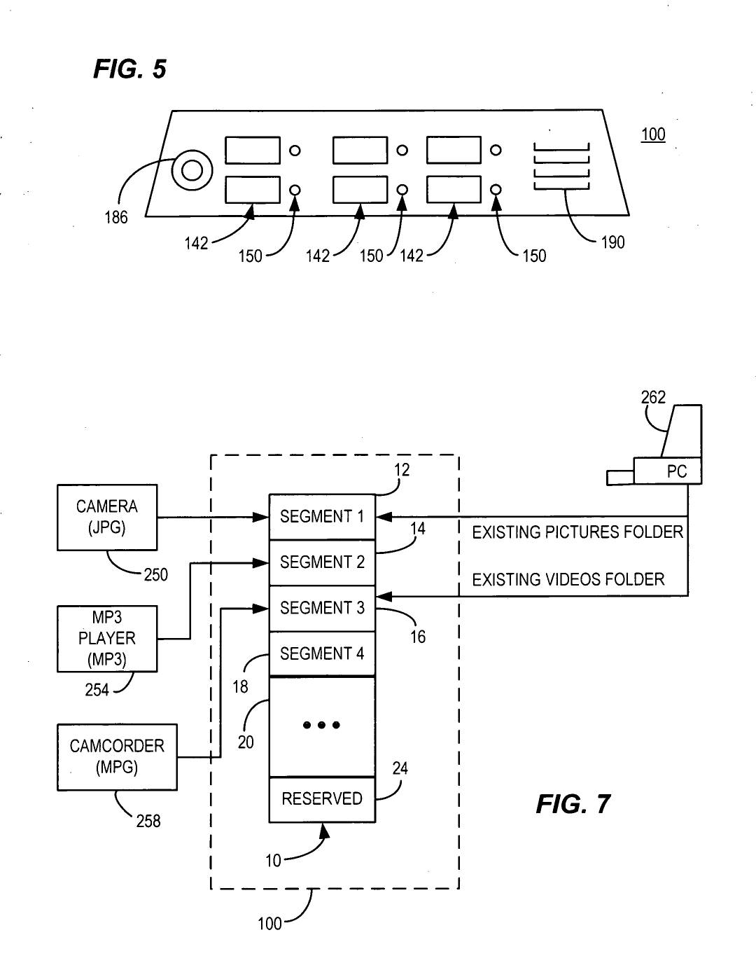

FIGS. 4-5 depict an embodiment of PSTD device 100 including flash memory card ports 130 on the front panel of FIG. 4 and USB ports 142 on the rear panel of FIG. 5. In the embodiment depicted, a set of indicator lights 150 are provided on the front and rear panel, one for each interface port 130 or 142. A port select button 154 is used to cycle through the ports in order to select a port to operate from. If a single external device is plugged in, the active port will default to the port having a connection, but if multiple devices are plugged in, the port select switch can be used to select among the various ports. The indicator lights can also be used to show whether the operation with that port is a success or failure.) In the present embodiments, eight segments of hard disk drive storage are provided for the user, and one segment selection button is provided for each of the segments in a button array 158, along with a clear button that is used to clear a prior or erroneous selection. A selected segment may be erased by selecting a segment and then pressing an erase button 158.

The power and operational status of the PSTD device 100 is provided with a status display light 162. When the light is red, an error has occurred. When the light is green the PSTD device 100 is ready for an operational command. A green light also shows that the last operation was successful. When the light is amber, an operation is in progress. Other color codes can also be used without deviation from embodiments of the invention.

An upload/download selector switch 166 is used to determine whether an upload or download operation is to occur. Operations are started by the start switch 170, and the PSTD device 100 is reset to receive commands for a new operation via the new action switch 174. The PSTD device 100 can also be used as an external hard disk drive which may be connected to any suitable compatible device via any suitable port such as one of the USB ports, in which case, toggling the external HDD toggle switch 178 enables operation as an external HDD. Hence, the PSTD acts as a normal HDD when it is toggled “on”, so that it can be used as an external HDD when hooked up to the computer, if the userjust wants a normal HDD. Thus, the PSTD can double up as a normal external HDD when the user is not traveling, thereby increasing its usefulness and versatility. A battery status indicator 182 can be provided for when the device is used under battery power, and also indicate when the battery is low. A/C power can be provided to power the PSTD device 100 at port 186, which can also serve to charge internal batteries in certain embodiments. A fan 190 can be provided for cooling if necessary. In certain embodiments, an LCD or LED screen can be provided for simple user interface (UI) feedback.

Preferably, the PSTD device 100 utilizes a small form factor hard disk drive to permit the device to be portable and on the order of 3-5 inches in length and about 3 inches in width so as to be “pocket sized”. However, other sizes are also possible without departing from embodiments consistent with the present invention.

### Data Upload and Download

Before examining the detailed operation of embodiments consistent with the present invention, it should be noted that the terms upload and download as used herein are with respect to the PSTD device 100. That is, an upload installs data from an external device into the PSTD device 100, while a download moves data from the PSTD device 100 to an external device.

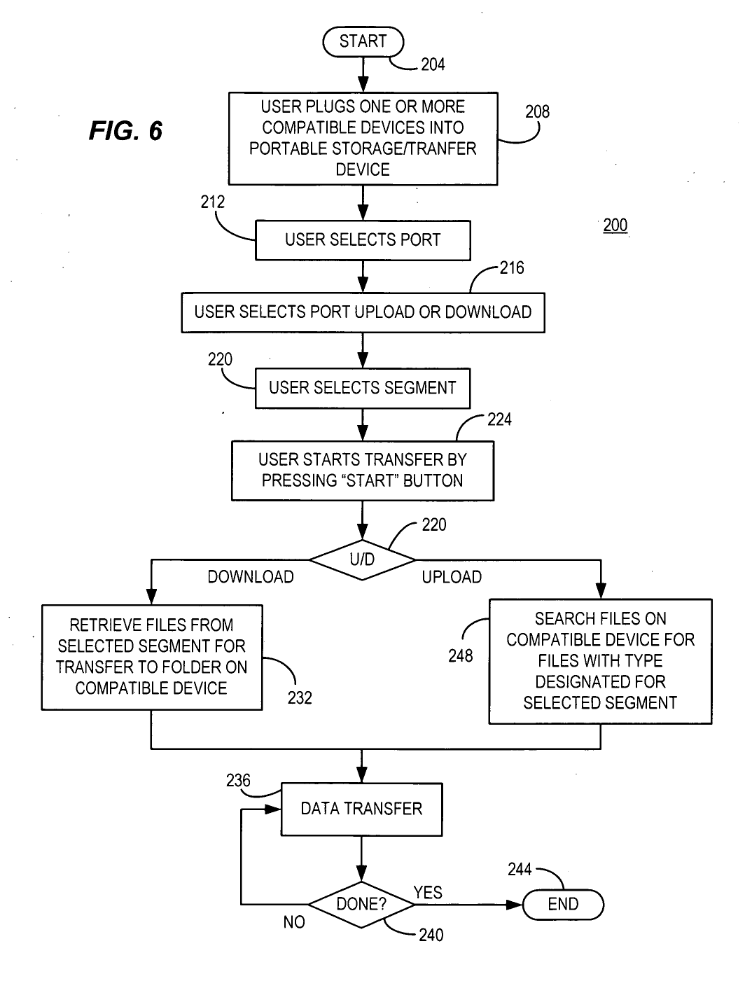

FIG. 6 describes a basic upload/download function of the PSTD device 100 as process 200 starting at 204 after which the user plugs one or more compatible devices into any of the compatible ports of the PSTD device 100 at 208. If a single device is plugged in, it becomes the default port and the corresponding port light 150 lights up. Otherwise, the user selects a port for the device of interest at 212 by pressing the port select switch 154 repeatedly until the proper port light 150 lights up. The user then selects an upload or download at 216 and a segment to either upload to or download from at 220. The order of operation in this case is not important for actions 208 through 220. The user then initiates the transfer by pressing the start button 170 to begin the transfer at 224. The action at this point depends on the status of the upload/download switch 166.

If the upload/download switch 166 is in the download position at 228, then a download operation is initiated at 232. Note that the user has designated a download from a selected segment to an external device. Thus, the data in the selected segment (which by definition has a specified filename extension or set of extensions) is transferred to the compatible device. In devices that use folder systems, a standardized folder is used which may be tailored to the particular device, or the data may simply transfer to a location (such as a user's desktop with a folder name such as “segment I”, or to a folder such as “my pictures”). In more sophisticated devices such as PCs, it is possible for the PC to manage the location of the download by asking for a target folder location in certain embodiments. The data transfer then begins at 236 until completed at 240 at which point the process ends at 244. In general, data remains in the originating device until deleted to avoid accidental deletion.

If the upload/download switch 166 is in the upload position at 228, a somewhat different process is carried out starting at 248. Recall that each segment of PSTD device 100 is designated for a particular filename extension (or set of extensions), and that one such segment has been selected. This filtering mechanism is also available to the download feature as well, and configured in the same manner. The user can always configure the PSTD device 100 to allow any file extensions if he/she wants it to be free. As such, there can be a case where the set of upload filters is different from the set of download filters. One such use can be, say, Upload allows jpg and download allows jpg and .ppt. The user can use this section to transfer jpeg pictures freely, and also at the same time use this section to push ppt files onto another computer. Prior to that, the user can place the ppt files into the PSTD by dragging and dropping them using his home PC. After which, he goes to his office PC and uploads all of them automatically. This can be useful because on his home computer, he may have ppt files all over his computer, and he only wants to transfer certain ppt files. But after selection, it is obvious that he would want to eventually download all these files to another device, which can be another PC, a TV/DVD recorder with memory or even a projector with memory.

In the illustrated embodiment, the compatible external device that has been selected is searched for files having matching filename extensions, and those files are copied to the selected segment of the segmented memory of PSTD device 100 at 236 until the last is copied at 240 and the process ends at 244.

This basic procedure can be used for either upload or download of content from or to the PSTD device 100 as described can be carried out from or to any port of the PSTD device 100 in the manner described.

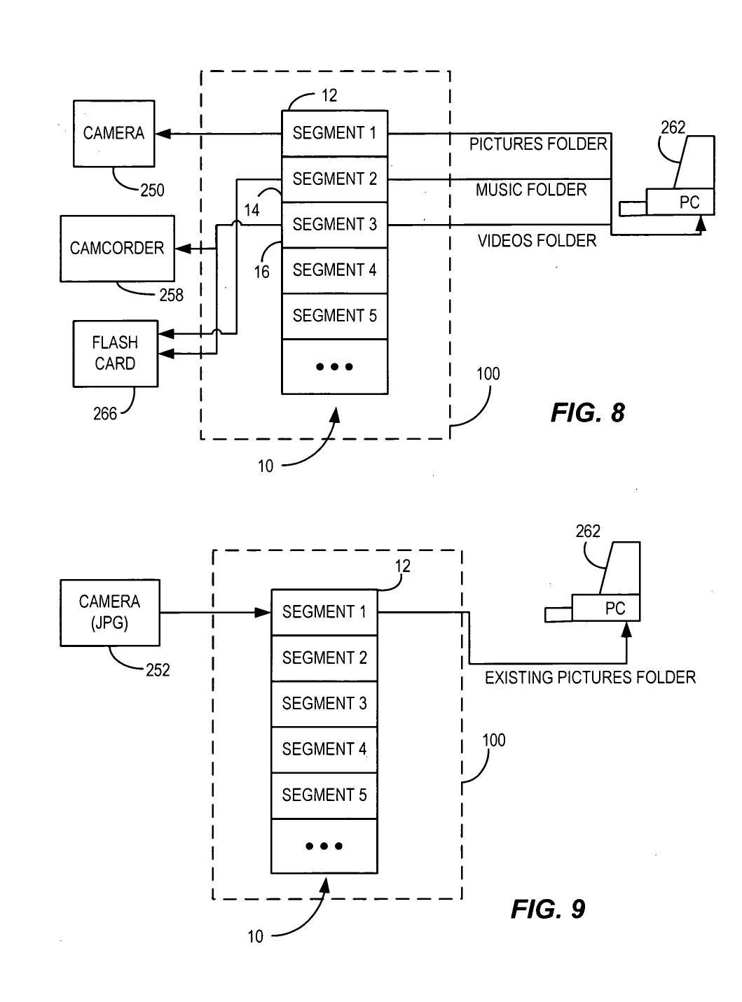

With reference to FIG. 7, the PSTD device 100 is generally depicted as 100 and shown with four example devices connected thereto. In this example and the example of FIGS. 8-9, the following segment mappings are assumed for convenience:

| SEGMENT | FILE TYPE |
|---|---|
| 1 | JPEG pictures (extension .jpg) |
| 2 | MPEG videos (extension .mpg) |
| 3 | MP3 music (extension .mp3) |
| remainder | Don't care, but none of the above |

In this example, any of camera 250, MP3 player 254, camcorder 258 or PC 262 can be used as the source device for an upload to the PSTD device 100. In this case, each connected device is mapped via the above segment mapping to the appropriate segment of memory for receipt of files of the appropriate type. By going through the process 200 as previously described, camera data from 250 can be designated for receipt by segment 1. In this case, when the start button 170 is activated, all jpg data from the camera is uploaded from camera 250 to segment 1. Similarly, device 100 can be configured to receive .mp3 data for segment 2 and mpg data for segment 3. Note that any of these devices may be multi-use devices (e.g., a telephone with an MP3 player and a camera, or a digital camera which can take pictures and videos) and may therefore be programmed only to copy one type of data to the appropriate segment. Subsequent operations can be used to copy other data.

In the case of PC 262, which may be considered a multi-use device, existing pictures can be transferred to segment 1, and in a subsequent operation, existing video pictures can be uploaded to segment 2.

In these drawings, multiple devices are shown connected so that the utility selecting a device port is emphasized, but it should also be noted that any of the transfers discussed can be effected one at a time by having only one external device connected to one port at a time.

While transfers generally happen sequentially, it should be noted that the operations can also be queued as will be described below. This is made possible by the “New Action” button 174 on the PSTD device 100. Hence, more than one device can be connected at the same time, and queued. Also, the same device can have more than one task in the queue. The hardware UI does not have to be in place throughout the entire transfer process. The software remembers the configuration once the “Start” Button is hit.

In FIG. 8 data flow is in the opposite direction. Following process 200, the PSTD device 100 can be programmed to send jpg data from segment 1 (12) to any or all of camera 250, PC 262 and flash card 266. Similarly, following process 200, music files in MP3 format can be transferred from segment 2 (14) to PC 262 or flash card 266. Video files can be similarly transferred from segment 3 (16) to camcorder 258, PC 262 or flash card 266 as desired.

Port selection/Task Queueing

The port selection feature allows the user to select ports which already has a media plugged in to perform requests as if the media has not been plugged in. This is useful if the user wishes to perform subsequent requests on the port that has already been assigned a request. To unplug the media from the port in order to initiate a subsequent request will disrupt the request chain, and this is not desired.

Because this feature simulates the condition of “plugging in” the media, the steps or acts used to call a request has not changed, and thus the user only needs to learn one universal way to make all kinds of requests the user needs on the PSTD device 100.

Generally, when the user plugs-in a device to a PSTD port 130 or 142, this action can be interpreted to initiate a request, and therefore without the new action button 174, the user would only be able to carry out one request at a time.

For computers, the user can probably do a re-detection of the USB port for media, but that would mean powering down that port and then powering it up again, which is different from this feature as it does not power down the port. This feature merely identifies the user's intention of re-using the port for additional requests. This feature allows the user to select ports which already has a media plugged in to perform requests as if the media has not been plugged in and allows the user to reuse the ports that have already been used.

The new action switch 174 signals processor 104 to simulate the condition of plugging in the media, the steps to call a request have not changed, and thus the user only needs to learn one universal way to make all kinds of requests the user needs on the PSTD, hence increasing the ease of user adaptability.

In order to carry out a queued action using the PSTD device 100, the following actions are taken. For example, to

1) Perform any request the standard way, eg perform a download from SD media to APDTC.
a) Toggle Download button
b) Select Section(s).
c) Plug in media into Port A (for SD card).

2) To reuse that SD media in port A for an upload from section 2, do the following:
a. Toggle upload button
b. Select section 2.
c. Hit port selection till the LED light for Port A lights up (it would be flickering before this as Port A will be performing the download request at this time. Upon selection, the flickering becomes a continuous light).
d. Hit “Enter” Button.
e. A new request is thus generated on hitting the “Enter” button.

Note: Items 2(c) and (d) together, are equivalent to step 1(c).

In another embodiment, a button can be used for each port for port selection.

### Two Step Data Pass Through

In the above illustrations, it is shown that data can either be uploaded to the PSTD device 100 or downloaded therefrom. Using two steps, it is thus possible to pass existing files from one external device to another using the PSTD device 100 as an intermediary. In the example of FIG. 9, data can first be loaded from camera 250 to segment 1 (12) using an upload process as described in 200, and then downloaded to a second external device such as PC 262 using a second iteration of the process 200. In this manner, data can be passed through. In this case, the user can also pre-configure the PSTD so that it does or does not retain the data that is being passed through.

### PC Source/Target Designations

Preferably the PSTD's internal software determines where the destination or source folder will be on the PC and it can be anywhere on the PC. Preferably, a working folder is created under “My Documents” or “documents” on Windows or a similar place on other Operating Systems. Under this working folder (user's choice), there are preferably two subfolders: Destination (not user's choice) and Source (not user's choice).

Under the Destination folder, whenever a transfer is being made to the folder, a new folder is created. For example, on first transfer, a folder named PSTD(1) is created and the data will be pushed into that folder from the PSTD device 100. On second transfer, if PSTD(1) exists, PSTD(2) will be created and the data will be pushed into that folder and so on. Otherwise, if PSTD(1) does not exist, it is created. This permits the folder to be renamed by the user into a more meaningful name. This process goes on for subsequent transfers, by starting from PSTD(1).

In an alternative embodiment, the PSTD remembers what index it should create to avoid duplication, ie, the folder created will flow from PSTD(1) PSTD(n), and each folder will be created only once ever. In another embodiment, a device ID can be appended to the name to make it unique between PSTDs, (e.g., PSTD_<device_ID>_<Folder Number>. Other attributes could also be added including date and time.

Note that these folders that are created on-the-fly will be automatically created in the PSTD software and does not require PC software such as a wizard to configure.

Under the source folder, the number of folders in the source folder will depend on the user's configuration on the number of segments the user created using the wizard. For example, if 3 segments are created, 3 folders will be created, and these folders will be the ones accessed when the PSTD is tasked to grab data from the PC for transfer into the specified segment on the PSTD. For example, segment I on PSTD will read from “Segment 1” folder under the source dir in the working dir on the PC.

So, the following is preferred directory structure, although others may be used without departing from embodiments consistent with the present invention:

My Documents
Destination folders created on the fly
Source folder created by wizard

Working dir for PSTD
Source Folder are segments pre-created when the user configures using the wizard.

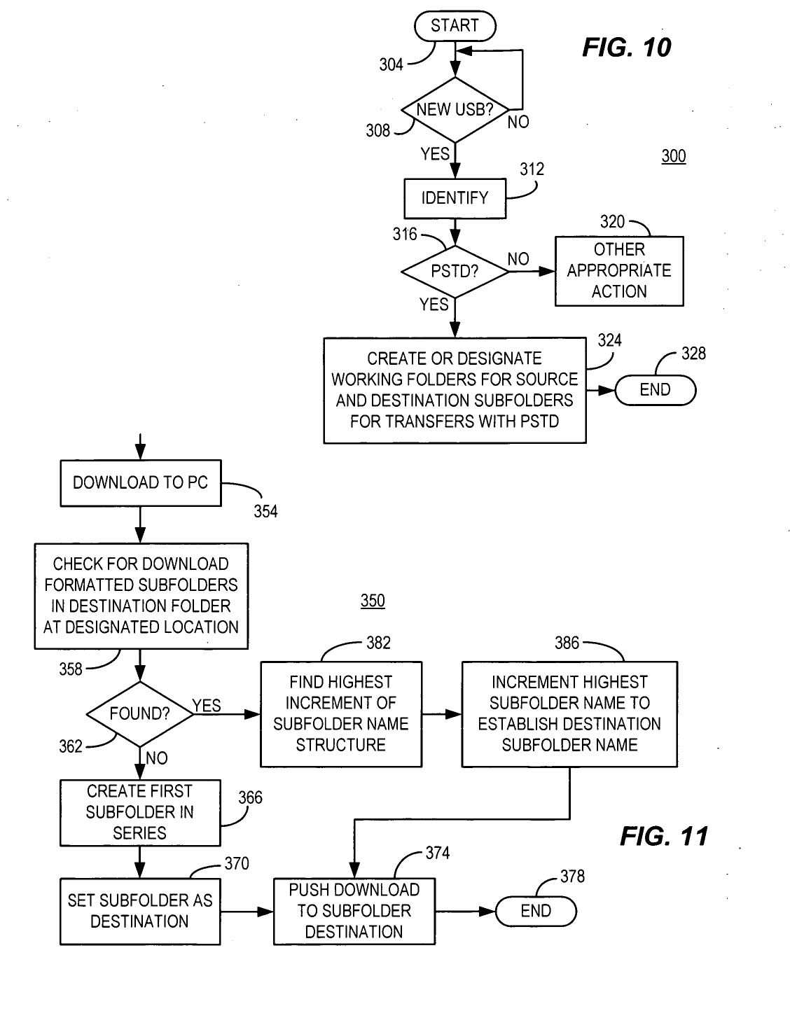

Normally, when a USB device is connected to a PC having plug 'n play capabilities, as with current windows XP and Vista powered personal computers and Apple personal computers, the USB device is recognized by the PC. This facilitates the ability to designate a location for storage of files that serve as a source or target for the files to or from the PSTD device 100. A configuration utility can be used on the PC to determine how to behave in communication with the PSDT device 100 in accord with the guidelines described above. One such configuration feature is described in connection with process 300 of FIG. 10 for configuring the PC's main source and destination folders starting at 304. The PC is continually looking for a new connection of a USB device (for example) at 308, and when one is identified at 308, it is identified at 312. Once identified, if it is not a first instance of a PSTD at 316, other appropriate action is taken. If it is the first instance of a PSTD device 100 connection, a wizard program creates with user input or designates a working folder for source and destination subfolders for transfers carried out with the PSTD at 324 and the process ends at 328

With reference to FIG. 11, the process used by the PSTD device 100 in downloading data and creation of folders as described in detail above is described more generally in flow chart form as process 350 starting at 354 where a download is initiated. At 358, the PSTD device 100 checks for download formatted subfolders (that is, subfolders under the designated destination folder having the proper naming convention) in a folder of designated location. If no subfolder is found, this is indicative that either it is a first download, or prior downloaded folders have been moved or renamed. Hence, control passes to 366 where a first subfolder is created using an established naming convention such as that described above. That subfolder is then designated as the destination subfolder at 370 and the files that are to be downloaded from a specified segment are pushed to the subfolder destination at 374 and the process ends at 378.

If a properly formatted subfolder is found at 362, the highest increment of the subfolder naming structure is found at 382 and that name is incremented at 386 to establish the destination folder for the download. Control then passes to 374 where the download is pushed and the process ends at 378.

It is noted that reference number 100 is used throughout this document to refer to the multiple variations of the PSTD device. Those skilled in the art will appreciate that the devices may differ somewhat but by virtue of sharing a common set of hardware and functional characteristics, one reference number is used throughout.

### Direct Transfer and Swap Modes

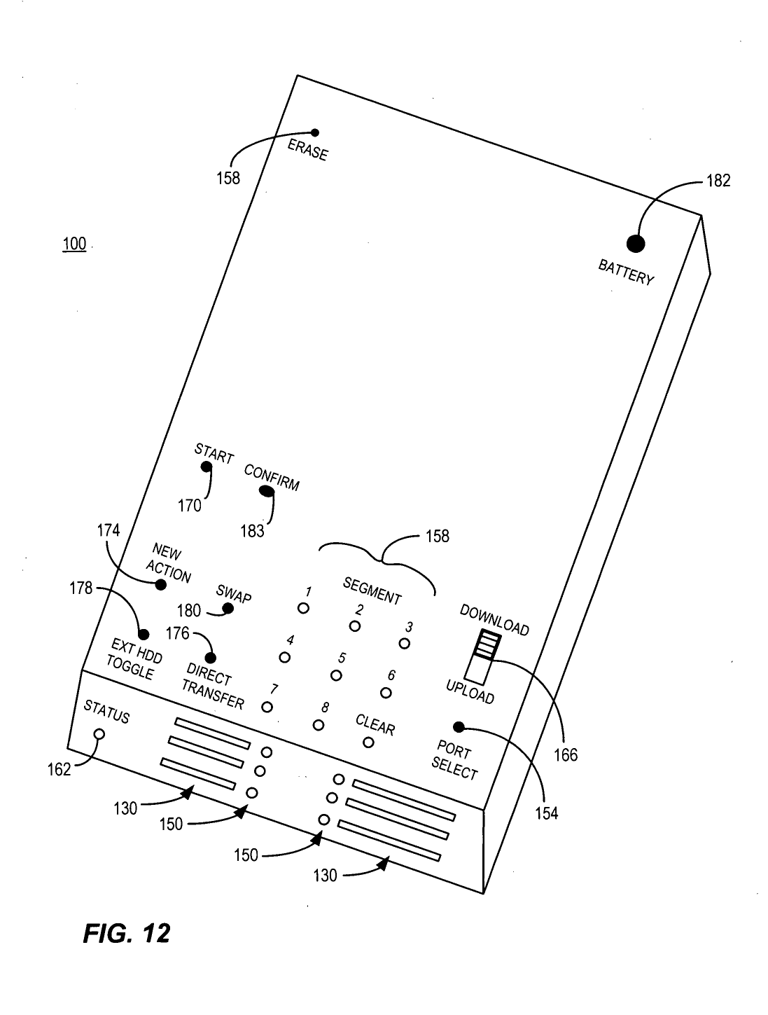

A variant of PSTD device 100 is depicted in FIG. 12. In this variation, two additional control elements (e.g., push buttons) have been added to the user interface in order to facilitate operation in two additional modes. In a first mode (direct transfer), the PSTD device 100 is used as an intermediary device to facilitate transfer of data between two external devices (e.g., a camera and a PC) in a single operation rather than two operations as described above. In a second mode (swap mode), the PSTD device 100 can be used as an intermediary. The direct transfer button 176 is used to enter a direct transfer mode of operation while the swap button is used to enter a swap mode as will be described. Those skilled in the art will appreciate, upon consideration of the present teachings, that multiple mechanisms and variations of the methods presented herein are possible without deviating from embodiments consistent with the present invention.

In these modes of operation, the user can either directly transfer data through the PSTD device 100, or can use the PSTD device 100 as an intermediary for swapping data with another external device. Additionally, the PSTD device 100 can be used in a swap mode in order to swap data from a designated segment of storage in the PSTD device 100's storage device 10. At a high level, the user selects a source and a destination for data and the data are either sent from source to destination through the PSTD device 100, or the data are swapped between the source and destination (in which event, both source and destination are both sources and destinations).

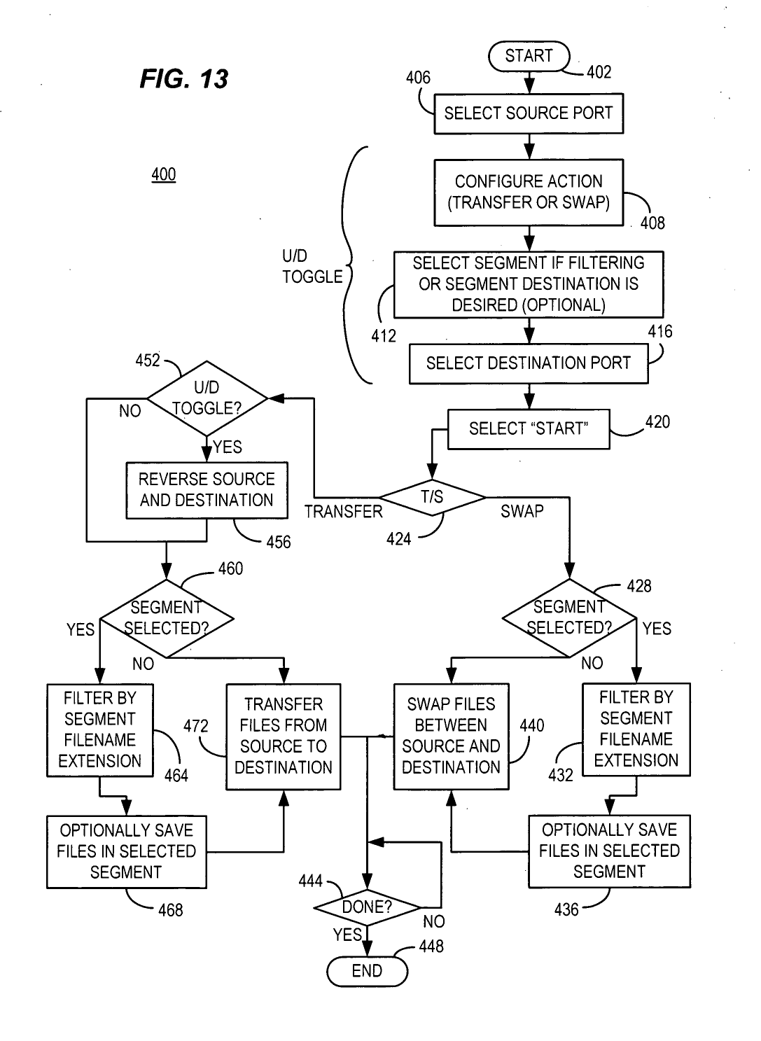

FIG. 13 depicts a first method 400 for operation of these modes starting at 402. At 406, the user selects a source port by either using the port select button 154 as described previously, or by default when plugging in an external device serving as a source. The user then configures the desired action, either transfer or swap) at 408 by pressing button 176 for transfer or 180 for swap. In the event of a swap, the “destination” can be a segment of the storage device 10, but can also be another external device. If a segment is selected at 412, it will be the desired “destination” for the swap, or the actual destination or source for a data transfer (in which case the device operates essentially as previously described). However, the selection of a segment at 412 is optional in the event the transfer or swap is to include all file types and only involves external devices. In this case or when more than one external device is serving as the source and the destination with the PSTD device 100 serving as intermediary (and not exclusive source or destination), the user designates the destination at 416. If no designation is made at 416, essentially the destination is designated at 412.

In another embodiment, an additional control button can be added to the user interface depicted as the “confirm” button 183 in FIG. 12. This optional button can be used to confirm the selection of the port. Button 183 can be used to confirm the port selection as well as any other purpose in which a confirmative action is desirable. This facilitates implementation of the port selection feature, especially when one wishes to queue a second task which involves the same source and a different destination.

In the event that both a segment and an external destination are selected, the designation of the segment is interpreted as an invocation of the filename extension associated with the segment as a filter on the data that are to be transferred or swapped. Depending upon configuration of the device, the designation of a segment may also invoke storage of a copy of the transferred data to the designated segment. In the case of a swap, data from both “sources” of the swap are stored in the selected segment.

By way of example, assume the designated source contains three files as follows:

file1.jpg

file2.mpg and

file3.jpg

In this example, the files are being transferred from external device A to external device B, both of which are plugged into the PSTD device 100. If segment I as defined in the table above is selected, the transfer will send file1.jpg and file3.jpg from external device A to external device B directly (with or without also saving a copy to segment 1 as will be described later). However, file2.mpg will not pass the filter and will not be transferred. This will be the case for either swap or direct transfer operation so far as movement of data from device A to device B is concerned.

Referring back to FIG. 13, process 400 proceeds with selection of start of the operation by pressing start button 170 at 420. In the event, any time from 408 to 416, the user realizes that the source and destination have been inadvertently interchanged, the upload download toggle switch 166 can be switched as illustrated by the bracket to reverse the source and destination. (Note that source and destination, strictly speaking is only relevant in the direct transfer mode).

Once the operation is initiated by the start operation at 420, the PSTD device 100 determines under processor control if the mode has been set to transfer or swap at 424. First consider the swap mode in which case control passes to 428 where a determination is made as to whether or not a segment has been selected. If so, the contents of the source are filtered according to the filename extension associated with the segment at 432. That is, only files having the filename extension associated with the selected segment are swapped between the source and destination. At 436, the files meeting the filter criterion are optionally copied to the selected segment (from both sources involved in the swap). This option can be implemented as a separate switch selection (not shown) or by configuration in an initial “wizard” configuration process as will be described later. In any case, at 440, files are swapped between the “source” and “destination” (both of which, in this mode may serve as sources and destinations provided they have files that meet the filter criterion). In the event a segment is not selected at 428, the entire contents of the source and destination are swapped without saving a copy in the intermediate segment. Note that a segment may be designated to have no filtering associated therewith (e.g., filename extension is .??? where question marks are used to represent wild card characters for example, or not designated at all in other embodiments). In this case, all files will pass through during direct transfer and swap operations. Data swaps initiated at 440 proceed until done at 444 at which point the process ends at 448. This concludes the swap operation.

In the event a direct transfer operation has been initiated at 424, the process determines if an upload/download switch 166 toggle took place during the bracketed time at 452. If so, the source and destination are reversed at 456 and control passes to 460. If not, action 456 is bypassed and control passes directly from 452 to 460. At 460, a determination is made as to whether or not a segment was selected at 412. If so, filtering is carried out by filename extension associated with the selected segment at 464 and the files are optionally saved to the selected segment at 468. File transfer is then initiated at 472 until completed at 444 at which point the direct file transfer operation is completed at 448.

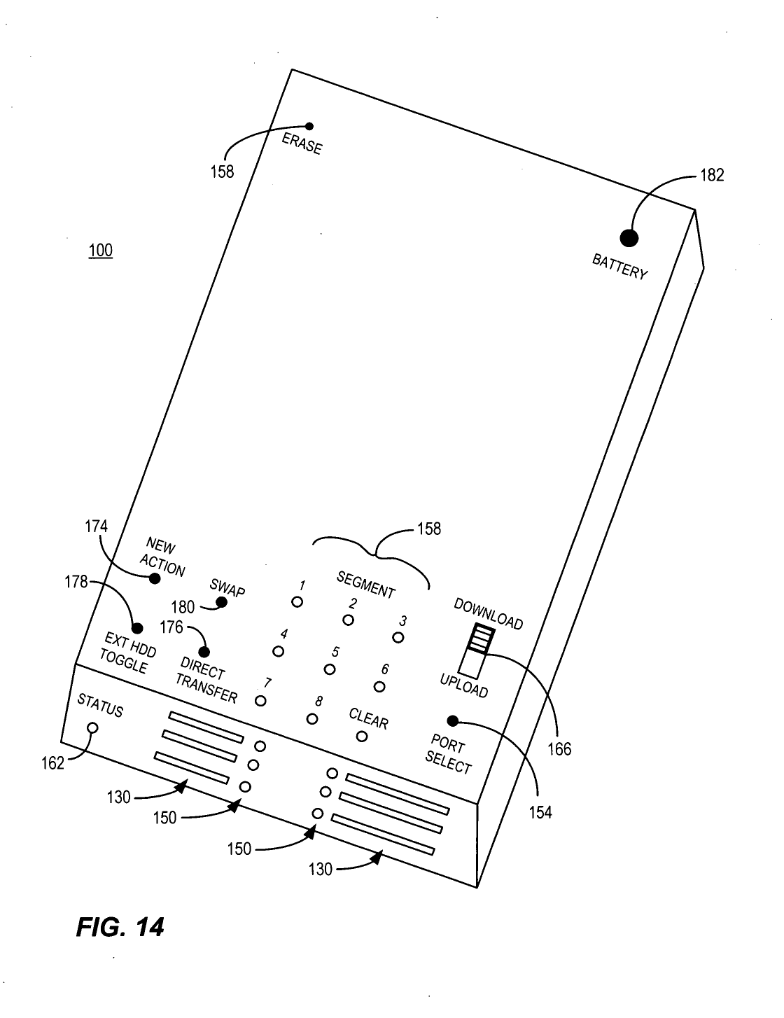

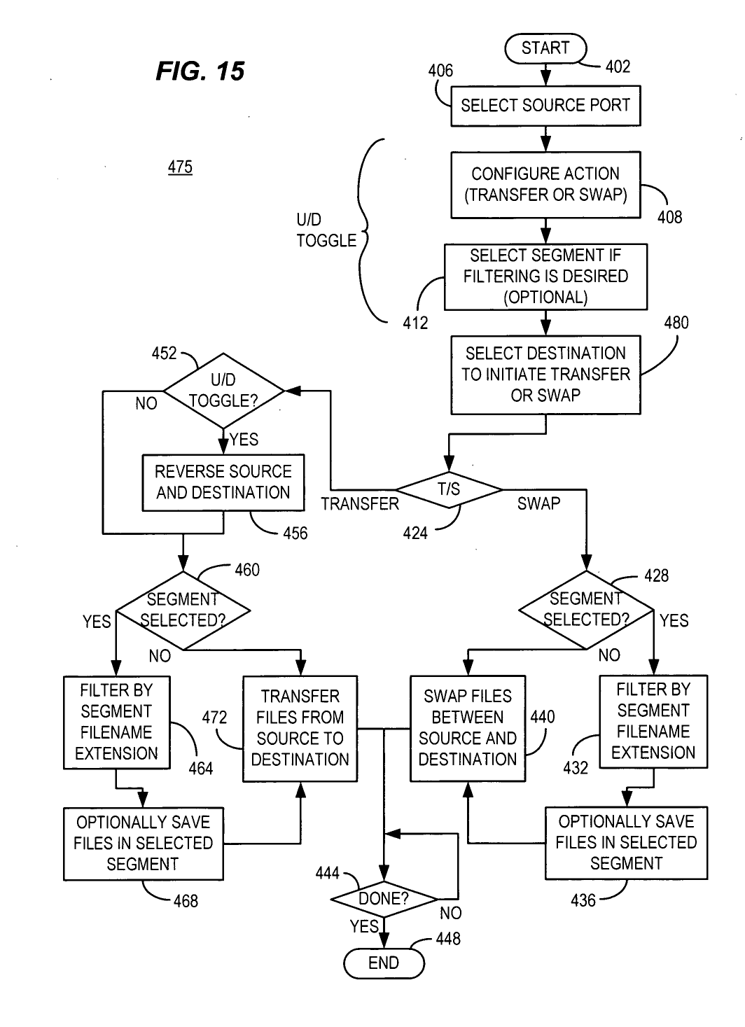

A variation of the PSTD device 100 of FIG. 13 is depicted in FIG. 14, the operation of which is described in connection with FIG. 15. In this embodiment, the PSTD 100 is essentially identical physically to that of FIG. 13. The only difference is omission of a “start” button 170, to illustrate that alternative operation can be carried out without need for the start button 170, by virtue of an implicit start command. In this case, all operations per FIG. 15 are the same as those in FIG. 13 except that the operations 416 and 420 are essentially merged, so that the selection of the destination initiates the swap or transfer operation. In this arrangement, a narrower margin for error exists since the upload/download toggle can only be used to reverse the source and destination before 480. Once a destination is selected, the operation commences. If an external destination is not desired in this embodiment, the segment button for the desired segment or segments can be pressed twice to indicate that the process is to commence. Other variations will occur to those skilled in the art upon consideration of the present teachings.

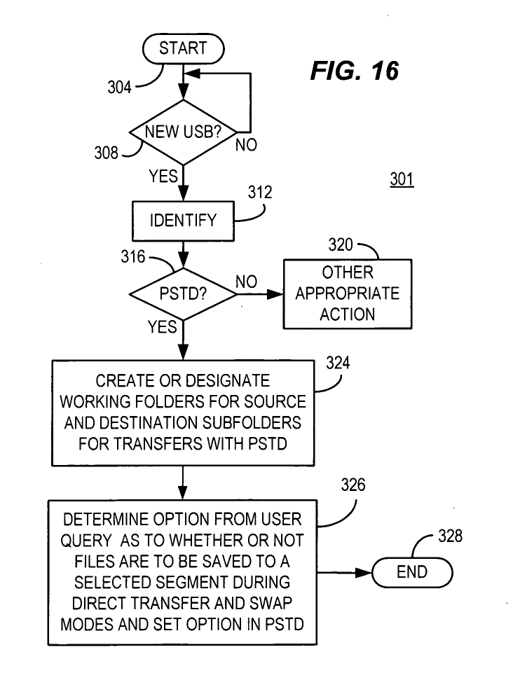

For embodiments having the direct transfer and swap features described above, an option is for the PSTD device 100 to save a copy of whatever is transferred between external devices (e.g., devices 252 and 262). In one embodiment, the user can use a separate or multifunction control on the PSTD device 100 itself to make the selection. In another embodiment, the factory can designate the selection. In another embodiment, the user can control the operation of the functions by making option selections during setup and configuration of the PSTD device 100. FIG. 16 depicts one technique in which the “wizard” setup program as depicted in FIG. 10 is modified in operation to query the user at 326 for preferences regarding whether the PSTD device 100 is to store or not store files passing therethrough when a segment is selected (in addition to use of the segment selection as a designation of filename extension filter).

Multiple Download/Upload from/to Multiple Ports

This feature allows multiple downloads/uploads from different media (card medias, PC or Laptops). When more than one media are detected, the multiple downloads/uploads feature can be automatically activated. This feature saves the user the trouble of transferring data in different media one at a time in the manner described and works using the port selection method described above. Instead of carrying out the operations one at a time, the user can program a multiple download, leave the system to run and tend to other business. This is especially useful if the user has both a digital camera and a camcorder which he/she wishes to download files from.

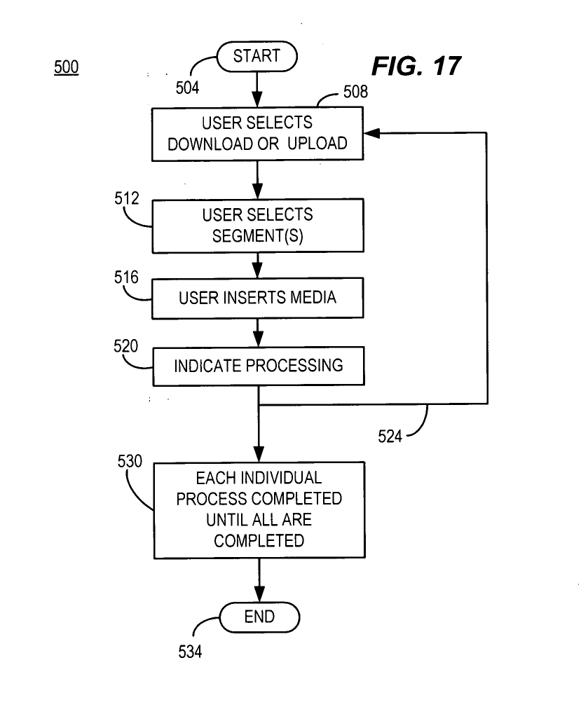

FIG. 17 is a flow chart describing the operation of programming a sequence of data transfer operations in accord with embodiments consistent with the present invention depicted as process 500 starting at 504.

The following shows the process of how this feature works.

1) The user indicates a download or an upload at 508 by toggling switch 166 on the PSTD device 100.

2) Then the user selects the segments at 512 of the PSTD device 100 he/she wants to download the data to/from a media (say an SD-card from the camera).

3) The user then inserts the media into the PSTD device 100 at 516.

4) An LED light will light up to show that this is being processed at 520. This process can then be repeated as indicated below and by arrow 524 as many times as desired to complete any sequence of actions, such as:

5) As with 1), the user indicates a download/upload by toggling switch 166 a button on the PSTD device 100.

6) As with 2), the user then selects another set of memory sections (may be the same) of the PSTD device 100 to download data to or from another media (say a Sony memory stick Pro Duo from a camcorder, for example).

7) As with 3), the user inserts the media into the PSTD device 100 and the action to download/upload will be automatically queued by the programmed processor.

8) As with 4) an LED light will light up to indicate the action's success or failure.

9) In a similar manner, the user can queue multiple download/upload requests up to the number of ports available for external media. Each individually programmed process can thus be completed one by one at 530 until all are complete and the process ends at 534.

Note that the procedure above can be carried out without use of the start button 170, and can thus be used in connection with the device of FIG. 14. A similar process can be devised for the device 100 depicted in FIG. 4. All the procedures are queued up and sequentially carried out by the programmed processor 104. There is no addition of hardware required for this feature. Hence, the PSTD device 100 allows for multiple downloads/uploads from different sources. This feature allows multiple downloads/uploads from different medias (card medias, PC or Laptops). At the processor 104, after each detection of a new media, the action, the memory sections, and the port ID are recorded and the request is queued. When this is done, the LED light will be activated to indicate success or failure, in the preferred implementation.

It does not matter if the user toggles the action button or selects the sections first. These settings will only be scanned upon the detection of a new media. So the user does not have to specifically remember which step to do first, other than the final step of inserting the card media.

This feature is particularly useful in certain embodiments because it is a very simple and neat way achieve multiple uploads/downloads from different sources. No additional hardware is required. The feature can be easily encoded in software and executed on the programmed processor 104.

Hence, as described above the PSTD device 100 can be used to recognize common file extensions used in digital cameras or camcorders like (JPEG, MPEG4, etc) and automatically downloads all files containing the extensions from the digital camera or camcorder (for example) onto the PSTD device 100. This electronic device 100 has a large capacity storage device (e.g., 80 GB or higher) to store the files. This electronic device has a programmed processor to allow for automatic downloads and preferably runs on either battery power or from a power outlet. Preferably the electronic device is small and slim to meet travel needs. PSTD device 100 is preferably compatible with common commercial memory card media like SD-Card, XD-Card and Sony's Memory Stick Pro Duo Media and further is compatible with all commercial digital cameras or camcorders because it relies only on compatible card medias, not the actual camera. The electronic device uses LED lights (Red, Orange and Green) to show download process, successful data transfer and failed data transfer or other suitable user interface.

Current memory card media have too little memory capacity to meet the technological advances with regards to the resolution of high definition still pictures and high definition video clips. Sony owns a proprietary Memory Stick Pro DuO™ Media, which has a memory capacity of as high as 8 GB. This, however even at this writing, such capacity is still small in the face of high definition video clips. Customers may also be reluctant to invest in such a costly card media since it is only 8 GB.

This PSTD device 100 can be made to be small and slim in order to readily meet travel needs. This device has a processor which is able to identify and download required files onto the 80 GB or even much higher hard disc drive memory of the device 100. A simple user interface provides for simplified downloads, hence increasing its ergonomic appeal. In many environments, the PSTD device 100 solves the problem of small memory capacity of card media. Because of its compatibility to existing card media, all customers who use the PSTD device 100 will be able to use it with their own existing cameras and card medias.

This device is pocket-sized, and hence is much more convenient than carrying a laptop. The simplified download feature also makes picture downloading more convenient than a laptop. This can be especially advantageous for hikers or campers who go on long expeditions, and weight is of importance. In such cases, a laptop is unfeasible, but the PSTD device 100 is feasible and will allow the hiker to take large volumes of pictures and videos on the hike without running out of memory space.

Thus, in certain embodiments, a method of transferring data from a source device to a destination device, using an intermediate device having pre-segmented storage involves receiving a user input associating a file type with a segment of the pre-segmented storage device; receiving a user input selecting a source port of the intermediate device; receiving a user input selecting a destination port of the intermediate device; receiving a user input selecting a segment of the pre-segmented storage device; determining a file type from the association of the selected segment of the pre-segmented storage device; and transferring the files of the determined file type from the source device to the destination device, wherein only files of the determined file type are transferred.

In certain embodiments, the method further involves storing the files transferred from the source device in the selected segment of the segmented memory. In certain embodiments, the determined file type has a filename extension for at least one of the plurality of data segments is one of jpg, mpg and .mp3. In certain embodiments, the one of the source and destination ports is connected to an external device that comprises one of a flash memory card, a camera, a camcorder, an MP3 player and a computer. In certain embodiments, the pre-segmented storage device comprises a hard disc drive. In certain embodiments, the transferring is further carried out from the destination device to the source device so that the contents are swapped. In certain embodiments, the transferred data are stored in the selected segment. In certain embodiments, the transferred data are stored in the selected segment. In certain embodiments, the port is one of a plurality of ports, and further comprising designating a port by repeatedly actuating a switch until the port to which the external device is coupled is designated. A computer readable storage medium storing instructions which, when executed on one or more programmed processors, can be used to carry out any of the methods described above.

A file storage and transfer device consistent with certain embodiments, has a user segmented data storage medium, the segmented data storage medium having designations of an arrangement of a plurality of data segments, wherein the data segment arrangement includes designation of a size and a filename extension for files that can be stored on each of the plurality of data segments, with other filename extensions being excluded from storage in the segment. A programmed processor controls data flow to and from the segmented data storage medium. A plurality of interface ports couple external devices to the file storage and transfer device. A user interface provides user commands to the file storage and transfer device and provides output displays, wherein one of the user commands designates which segment is active in the segmented data storage device for a specified operation. The processor receives user inputs that: associate a file type with a segment of the pre-segmented storage device; select a source port of the intermediate device; select a destination port of the intermediate device; select a segment of the pre-segmented storage device, The processor determines a file type from the association of the selected segment of the pre-segmented storage device. The processor transfers the files of the determined file type from the source device to the destination device, wherein only files of the determined file type are transferred.

In certain embodiments, the processor stores the files transferred from the source device in the selected segment of the segmented memory. In certain embodiments, the determined file type has a filename extension for at least one of the plurality of data segments is one of jpg, .mpg and .mp3. In certain embodiments, the one of the source and destination ports is connected to an external device that comprises one of a flash memory card, a camera, a camcorder, an MP3 player and a computer. In certain embodiments, the pre-segmented storage device comprises a hard disc drive. In certain embodiments, the transferring is further carried out from the destination device to the source device so that the contents are swapped In certain embodiments, the transferred data are stored in the selected segment. In certain embodiments, the transferred data are stored in the selected segment. In certain embodiments, the port is one of a plurality of ports, and further comprising designating a port by repeatedly actuating a switch until the port to which the external device is coupled is designated.

In certain embodiments, a file storage and transfer device has a user segmented data storage medium in the form of a hard disk drive, the segmented data storage medium having designations of an arrangement of a plurality of data segments, wherein the data segment arrangement includes designation of a size and a filename extension for files that can be stored on each of the plurality of data segments, with other filename extensions being excluded from storage in the segment. A programmed processor controls data flow to and from the segmented data storage medium. A plurality of interface ports couple external devices to the file storage and transfer device. A user interface provides user commands to the file storage and transfer device and provides output displays, wherein one of the user commands designates which segment is active in the segmented data storage device for a specified operation. The processor receives user inputs that: associate a file type with a segment of the pre-segmented storage device wherein the file type has a filename extension for at least one of the plurality of data segments is one of jpg, .mpg and mp3; selects a source port of the intermediate device; selects a destination port of the intermediate device; and selects a segment of the pre-segmented storage device. The processor determines a file type from the association of the selected segment of the pre-segmented storage device. The processor transfers the files of the determined file type from the source device to the destination device, wherein only files of the determined file type are transferred. The processor stores the files transferred from the source device in the selected segment of the segmented memory. The one of the source and destination ports is connected to an external device that is one of a flash memory card, a camera, a camcorder, an MP3 player and a computer.

In certain embodiments, the transferring is further carried out from the destination device to the source device so that the contents are swapped. In certain embodiments, the transferred data are stored in the selected segment. In certain embodiments, the port is one of a plurality of ports, and further comprising designating a port by repeatedly actuating a switch until the port to which the external device is coupled is designated. In certain embodiments, the external device comprises one of a flash memory card, a camera, a camcorder, an MP3 player and a computer. In certain embodiments, the transferring is carried out from the designated data segment to the external device, and wherein the transfer is carried out to a destination folder that is created by the programmed processor in accord with a folder naming convention.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using a programmed processor executing programming instructions that are broadly described above in flow chart form that can be stored on any suitable electronic or computer readable storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of transferring data from a source device to a destination device, using an intermediate device having pre-segmented storage, comprising:
receiving a user input associating a file type with a segment of the pre-segmented storage device;
receiving a user input selecting a source port of the intermediate device;
receiving a user input selecting a destination port of the intermediate device;
receiving a user input selecting a segment of the pre-segmented storage device;
determining a file type from the association of the selected segment of the pre-segmented storage device; and
transferring the files of the determined file type from the source device to the destination device, wherein only files of the determined file type are transferred.

2. The method according to claim 1, further comprising storing the files transferred from the source device in the selected segment of the segmented memory.

3. The method according to claim 1, wherein the determined file type has a filename extension for at least one of the plurality of data segments is one of jpg, mpg and .mp3.

4. The method according to claim 1, wherein the one of the source and destination ports is connected to an external device that comprises one of a flash memory card, a camera, a camcorder, an MP3 player and a computer.

5. The method according to claim 1, wherein the pre-segmented storage device comprises a hard disc drive.

6. The method according to claim 1, wherein the transferring is further carried out from the destination device to the source device so that the contents are swapped.

7. The method according to claim 7, wherein the transferred data are stored in the selected segment.

8. The method according to claim 1, wherein the transferred data are stored in the selected segment.

9. The method according to claim 1, wherein the port is one of a plurality of ports, and further comprising designating a port by repeatedly actuating a switch until the port to which the external device is coupled is designated.

10. A computer readable storage medium storing instructions which, when executed on one or more programmed processors, carry out a method according to claim 1.

11. A file storage and transfer device, comprising in combination:
a user segmented data storage medium, the segmented data storage medium having designations of an arrangement of a plurality of data segments, wherein the data segment arrangement includes designation of a size and a filename extension for files that can be stored on each of the plurality of data segments, with other filename extensions being excluded from storage in the segment;
a programmed processor controlling data flow to and from the segmented data storage medium;
a plurality of interface ports for coupling external devices to the file storage and transfer device;
a user interface for providing user commands to the file storage and transfer device and for providing output displays, wherein one of the user commands designates which segment is active in the segmented data storage device for a specified operation;
wherein, the processor receives user inputs that:
associate a file type with a segment of the pre-segmented storage device;
select a source port of the intermediate device;
select a destination port of the intermediate device;
select a segment of the pre-segmented storage device;
the processor determining a file type from the association of the selected segment of the pre-segmented storage device; and
the processor transferring the files of the determined file type from the source device to the destination device, wherein only files of the determined file type are transferred.

12. The device according to claim 11, further comprising the processor storing the files transferred from the source device in the selected segment of the segmented memory.

13. The device according to claim 12, wherein the determined file type has a filename extension for at least one of the plurality of data segments is one of jpg, .mpg and .mp3.

14. The device according to claim 11, wherein the one of the source and destination ports is connected to an external device that comprises one of a flash memory card, a camera, a camcorder, an MP3 player and a computer.

15. The device according to claim 11, wherein the pre-segmented storage device comprises a hard disc drive.

16. The device according to claim 11, wherein the transferring is further carried out from the destination device to the source device so that the contents are swapped.

17. The method according to claim 16, wherein the transferred data are stored in the selected segment.

18. The method according to claim 11, wherein the transferred data are stored in the selected segment.

19. The method according to claim 11, wherein the port is one of a plurality of ports, and further comprising designating a port by repeatedly actuating a switch until the port to which the external device is coupled is designated.

20. A file storage and transfer device, comprising in combination:
a user segmented data storage medium in the form of a hard disk drive, the segmented data storage medium having designations of an arrangement of a plurality of data segments, wherein the data segment arrangement includes designation of a size and a filename extension for files that can be stored on each of the plurality of data segments, with other filename extensions being excluded from storage in the segment;
a programmed processor controlling data flow to and from the segmented data storage medium;
a plurality of interface ports for coupling external devices to the file storage and transfer device;
a user interface for providing user commands to the file storage and transfer device and for providing output displays, wherein one of the user commands designates which segment is active in the segmented data storage device for a specified operation;
wherein, the processor receives user inputs that:
associate a file type with a segment of the pre-segmented storage device wherein the file type has a filename extension for at least one of the plurality of data segments is one of jpg, mpg and .mp3;
select a source port of the intermediate device;
select a destination port of the intermediate device;
select a segment of the pre-segmented storage device;
the processor determining a file type from the association of the selected segment of the pre-segmented storage device;
the processor transferring the files of the determined file type from the source device to the destination device, wherein only files of the determined file type are transferred;
the processor storing the files transferred from the source device in the selected segment of the segmented memory;
wherein the one of the source and destination ports is connected to an external device that comprises one of a flash memory card, a camera, a camcorder, an MP3 player and a computer.

21. The device according to claim 20, wherein the transferring is further carried out from the destination device to the source device so that the contents are swapped.

22. The method according to claim 20, wherein the transferred data are stored in the selected segment.

23. The method according to claim 20, wherein the port is one of a plurality of ports, and further comprising designating a port by repeatedly actuating a switch until the port to which the external device is coupled is designated.

24. The device according to claim 20, wherein the external device comprises one of a flash memory card, a camera, a camcorder, an MP3 player and a computer.

25. The device according to claim 20, wherein the transferring is carried out from the designated data segment to the external device, and wherein the transfer is carried out to a destination folder that is created by the programmed processor in accord with a folder naming convention.
